(19) United States
(12) Patent Application Publication
(10) Pub. No.: US 2026/0054449 A1
(43) Pub. Date: Feb. 26, 2026

(54) MICROLEDS TO IMPROVE 3D PRINTING

(71) Applicant: Applied Materials, Inc., Santa Clara, CA (US)

(72) Inventors: Joseph R. JOHNSON, Redwood City, CA (US); Christopher Dennis BENCHER, Santa Clara, CA (US); Mingwei ZHU, San Jose, CA (US)

(21) Appl. No.: 19/300,214

(22) Filed: Aug. 14, 2025

Related U.S. Application Data
(60) Provisional application No. 63/686,458, filed on Aug. 23, 2024.

(51) Int. Cl. B29C 64/135; B29C 64/277; B33Y 10/00; B33Y 30/00; B33Y 50/02

(52) U.S. Cl. CPC B29C 64/135; B29C 64/277; B33Y 10/00; B33Y 30/00; B33Y 50/02

(57) ABSTRACT

Embodiments of the present disclosure generally relate to liquid interface 3D printing methods and devices. The device includes a backplane, the backplane having a backplane surface, the backplane surface including a plurality of LEDs, sub-pixel isolation (SI) structures disposed over the backplane surface and between the plurality of LEDs, the SI structures defining a plurality of wells, the plurality of wells having a transparent material disposed in the plurality of wells, a stage, the stage disposed over the plurality of wells, a resin well, the resin well disposed over the stage, and a plurality of resin channels, the plurality of resin channels coupled to the resin well, the resin channels extending through the backplane, the wells and the stage.

### CROSS-REFERENCE TO RELATED APPLICATION

This application claims the benefit of U.S. Provisional Ser. No. 63/686,458, filed Aug. 23, 2024, which is incorporated by reference herein in its entirety.

### BACKGROUND

### Field

Embodiments of the present disclosure generally relate to liquid interface 3D printing methods and devices. Specifically, embodiments described herein provide methods and devices for supplying liquid resin to a 3D printing interface and curing portions of 3D printed part with light emitting diodes (LEDs).

### Description of the Related Art

A light emitting diode (LED) panel uses an array of LEDs, with individual LEDs providing the individually controllable pixel elements that are incorporated in a variety of devices. The devices include, but are not limited to implemented biology devices for DNA synthesis, DNA sequencing, protein prototyping, photocontrolled polymer synthesis, 3D printing devices, drug discovery devices, LED displays, and any devices include that LED pixels having LEDs described herein. The devices may include LED of different sizes or LEDs of different wavelengths dependent on the implementation.

Current 3D printing methods and devices use a light source and a means for specially controlling the light source to direct the light towards the 3D printed part to cure the resin to build the 3D printed part. For example, a plane of light can be digitized with LCD pixels to control where light is directed. Further, liquid resin is manually or externally supplied to a printing stage in order to continuously print a 3D printed part. After incrementally building the 3D printed part the 3D printed part is transferred to a separate system to complete the UV cure.

Although current 3D printing methods and devices represent a technological leap in 3D printing technology, challenges to fabricate detailed 3D printed parts remain. For example, current manufacturing procedures can be simplified and provide a detailed cure to a 3D printed part. Accordingly, there is a need in the art for improved 3D printing methods and devices.

### SUMMARY

In one embodiment, a device is disclosed. The device includes a backplane, the backplane having a backplane surface, the backplane surface including a plurality of LEDs, sub-pixel isolation (SI) structures disposed over the backplane surface and between the plurality of LEDs, the SI structures defining a plurality of wells, the plurality of wells having a transparent material disposed therein, a stage, the stage disposed over the plurality of wells, and a resin well, the resin well disposed over the stage.

In another embodiment, a device is provided. The device includes a backplane, the backplane having a backplane surface, the backplane surface including a plurality of LEDs, sub-pixel isolation (SI) structures disposed over the backplane surface and between the plurality of LEDs, the SI structures defining a plurality of wells, the plurality of wells having a transparent material disposed in the plurality of wells, a stage, the stage disposed over the plurality of wells, a resin well, the resin well disposed over the stage, and a plurality of resin channels, the plurality of resin channels coupled to the resin well, the resin channels extending through the backplane, the wells and the stage.

In another embodiment, a method for fabricating a printed part is provided. The method for fabricating a printed part includes supplying a liquid resin to a resin well via a plurality of resin channels, curing the liquid resin via a light emitted by a plurality of LEDs according to a pattern, the plurality of LEDs disposed within a device, the device comprising, a backplane, the backplane having a backplane surface, the backplane surface including the plurality of LEDs, sub-pixel isolation (SI) structures disposed over the backplane surface and between the plurality of LEDs, the SI structures defining a plurality of wells, the plurality of wells having a transparent material disposed therein, a stage, the stage disposed over the wells, and the resin well, the resin well disposed over the stage, lifting the printed part at least partially from the resin well, the printed part comprising cured resin, lowering the printed part into the resin well, and supplying additional liquid resin to the resin well through the plurality of resin channels.

### BRIEF DESCRIPTION OF THE DRAWINGS

FIG. 1A is a cross-sectional view of a 3D printing stage having a first LED arrangement, according to some embodiments.

FIG. 1B is a cross-sectional view of a 3D printing stage having a second LED arrangement, according to some embodiments.

FIG. 1C is a cross-sectional view of a 3D printing stage having a third LED arrangement, according to some embodiments.

FIG. 1D is a cross-sectional view of a 3D printing stage having a microlens array arrangement, according to some embodiments.

FIG. 1E is a cross-sectional view of a 3D printing stage having a resin channel arrangement, according to some embodiments.

FIG. 2 is a flow diagram of a method of fabricating a 3D printed part, according to some embodiments.

FIGS. 3A-3D is cross-sectional view of a 3D printing stage during the fabrication of a 3D printed part, according to some embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to liquid interface 3D printing methods and devices. Specifically, embodiments described herein provide methods and devices for supplying liquid resin to a 3D printing interface and curing portions of 3D printed part with light emitting diodes (LEDs). LEDs used in 3D printing devices and methods are used to cure resin to print a 3D part. The process of 3D printing described herein utilizes fewer steps and provides a more controlled curing process than other processes of 3D printing. By utilizing fewer steps, the process described herein reduces the time required to print a 3D part. By providing a more controlled curing process, more details may be provided to the 3D printed part.

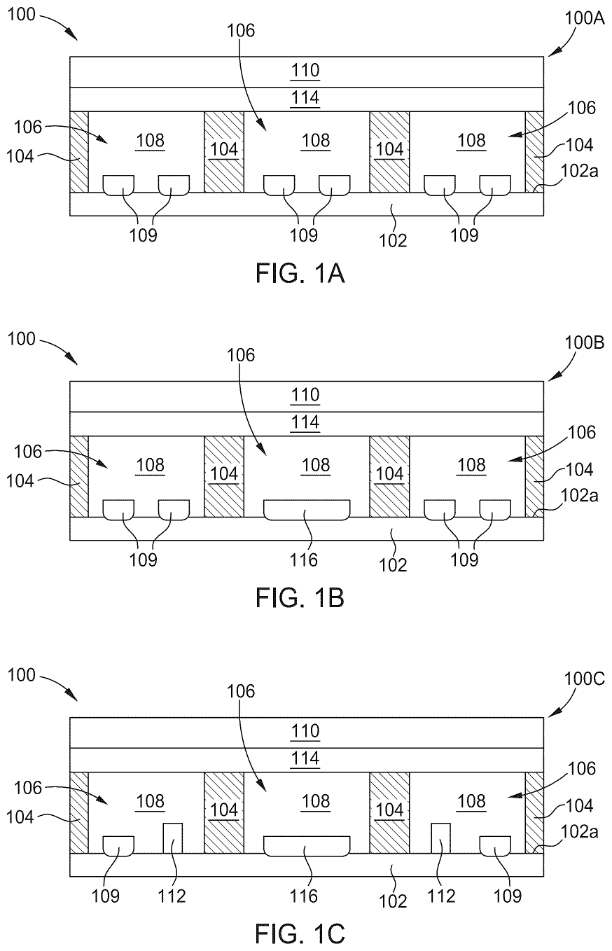

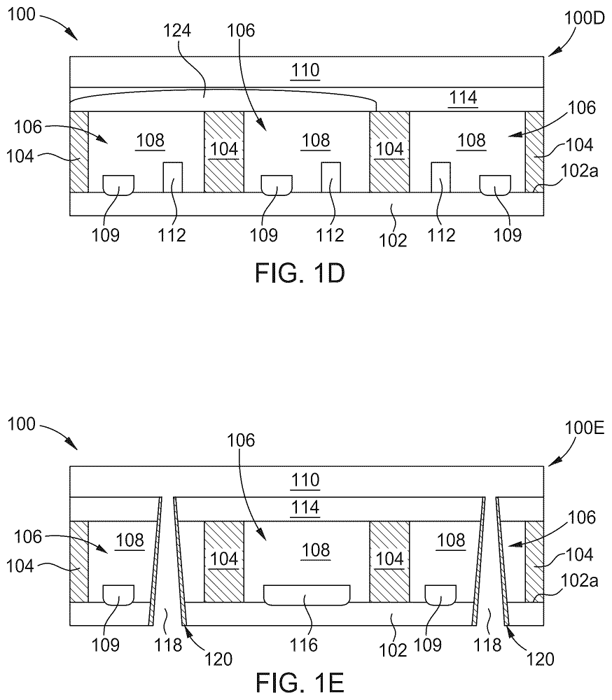

FIG. 1A is a cross-sectional view of a 3D printing stage 100 having a first LED arrangement 100A. FIG. 1B is a cross-sectional view of a 3D printing stage 100 having a second LED arrangement 100B. FIG. 1C is a cross-sectional view of a 3D printing stage 100 having a third LED arrangement 100C. FIG. 1D is a cross-sectional view of a 3D printing stage 100 having a microlens array arrangement 100D. FIG. 1E is a cross-sectional view of a 3D printing stage 100 having a resin channel arrangement 100E. The backplane 102 includes a backplane surface 102a. The backplane surface 102a includes a plurality of LEDs 109. The LEDs 109 include pairs of backplane electrodes (not pictured) and LED electrodes (not pictured). The LEDs of the present disclosure may be micro-LEDs.

The LEDs 109 are integrated with backplane circuitry so that each LED 109 can be individually addressed. For example, the circuity of the backplane can include a TFT active matrix array with a thin-film transistor and a storage capacitor (not illustrated) for each LED 109, column address and row address lines, column and row drivers, to drive the LEDs 109. Alternatively, the LEDs 109 can be driven by a passive matrix in the backplane circuitry. The backplane 102 can be fabricated using conventional complementary metal-oxide silicon (CMOS) process. Each LED 109 is configured to emit low wavelength light in a wavelength range. For example, the low wavelength light emits in a wavelength range of about 365 nm to about 450 nm. The size of the LEDs 109 may be about 30 μm by 30 μm to about 10 μm by 10 μm.

Sub-pixel isolation (SI) structures 104 are disposed over the backplane surface 102a. The SI structures 104 are disposed around the LEDs 109. The SI structures 104 may include organic material. The organic material may be an epoxy-based photoresist or a negative tone photoresist. Adjacent SI structures 104 form a plurality of wells 106 around the LEDs 109. A transparent material 108 is disposed within each well of the plurality of wells 106. The transparent material 108 may be any material that is optically transparent, such as an epoxy material, which low wavelength light to pass through the transparent material 108. A stage 114 is disposed over the SI structures 104 and the plurality of wells 106. The stage 114 includes a transparent material such as glass. A resin well 110 is disposed over the stage 114.

As shown in FIG. 1A, two LEDs of the plurality of 109 are positioned in the wells 106. Although two LEDs of the plurality of LEDs 109 are shown in FIG. 1A, it should be understood any number of LEDs 109 may be disposed over the backplane 102 in each well as space allows. The plurality of LEDs 109 allows for detailed control of the light emitted from the LEDs 109 through the stage 114 to the resin well 110. Further, each LED in a plurality of LEDs 109 may include a different wavelength to allow for further control of the curing process as described in Method 200.

As shown in FIG. 1B, the LEDs 109 may include a plurality of sizes. For example, the large LED 116 disposed over the backplane 102 differs in size compared to the LEDs 109 disposed over the backplane 102. It should be understood that any well 106 may include an LED 109 of a different size (e.g., the large LED 116). The varied size of the LEDs 109 allows for further control of light emitted through the stage 114 to the resin for the curing process as described in Method 200.

As shown in FIG. 1C, a sensor 112 is disposed over the backplane 102 adjacent to a LED of the plurality of LEDs 109, which is also disposed over the backplane 102. Each well of the plurality of wells 106 may include any number of LEDs 109 or sensors 112. Further, each well 106 may include a plurality of LEDs 109 emitting different wavelengths of low wavelength light and different sensors 112. The sensors 112 may include an optical sensor, a temperature sensor, and/or a pressure sensor. The sensor 112 may relay the status of the curing process or detect imperfections during the curing process.

As shown in FIG. 1D, a microlens or a microlens array 124 is disposed over the stage 114. The microlens array 124 extends over at least one well of the plurality of wells 106. As shown in FIG. 1D, the microlens array 124 extends over two wells of the plurality of wells 106. The plurality of wells 106 include at least one LED of the plurality of LEDs 109. The plurality of wells 106 may include a plurality of sensors 112 or a plurality of resin channels 120. The microlens array 124 allows for control of the spot size of low wavelength light emitted but the plurality of LEDs 109. Additionally or alternatively, the microlens array 124 compensates for a dead zone within a well of the plurality of wells 106. For example, a well of the plurality of wells 106 includes a LED 109 and a sensor 112 and the adjacent well (one of the plurality of wells 106) includes a LED of the plurality of LEDs and a sensor of the plurality of sensors 112 (as shown in Figure1D), a dead zone forms above each sensor 112 (e.g., no low wavelength light is emitted above the sensor 112 because there is no LED disposed in position on the backplane 102). The microlens array 124 is operable to direct low wavelength light emitted from the plurality of LEDs 109 disposed in the adjacent well in order to provide an even and controlled UV cure.

As shown in FIG. 1E, at least one resin channel of the plurality of resin channels 120 couples to the resin well 110 and extends through the backplane 102, the well 106, and the stage 114. Liquid resin 118 is disposed within the resin channel 120. As shown in FIG. 1E, one resin channel 120 and one LED 109 is disposed in one well of the plurality of wells 106. Alternatively or additionally, a plurality of resin channels 120 may be disposed in the individual well of the plurality of wells 106. Further, alternatively or additionally, a plurality of LEDs 109 may be disposed within the well with one or more of the plurality of resin channels 120. Further, it is contemplated that a sensor 112 may be disposed within the well along with one or more LEDs 109 and one or more of the plurality resin channels 120.

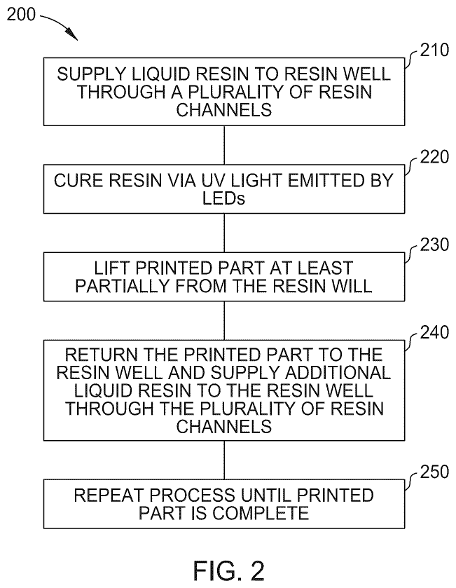

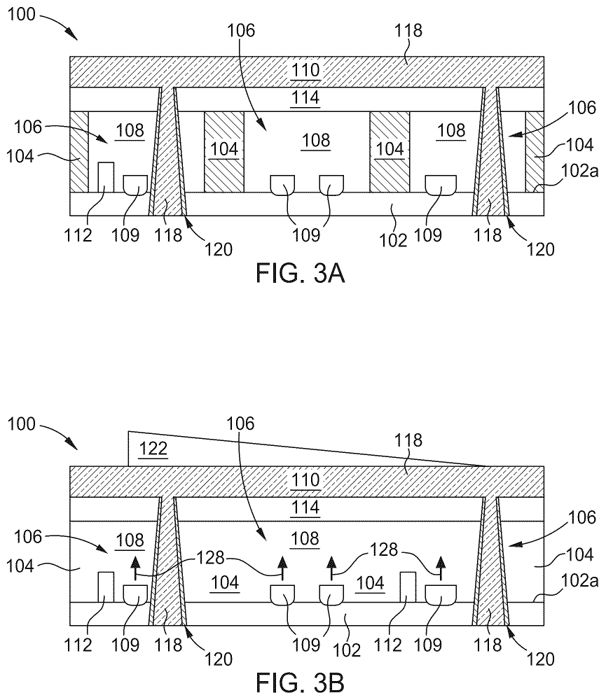

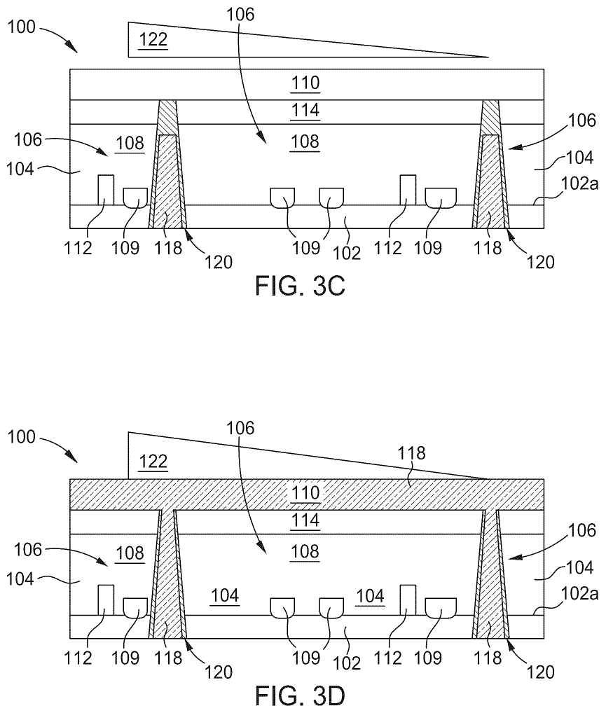

FIG. 2 is a flow diagram of a method 200 of fabricating a 3D printed part 122. The method 200 includes incrementally curing liquid resin 118 with LEDs 109 to 3D print the printed part 122. FIGS. 3A-3D are schematic, cross-sectional views of the 2D printing stage 100 during method 200. The printed part 122 is printed according to a pattern.

At operation 210, as shown in FIG. 3A, liquid resin 118 is supplied to the resin well 110 via the plurality of resin channels 120. The plurality of resin channels 120 are microfluidic channels. The liquid resin 118 is supplied from a resin source (not pictured). The liquid resin 118 is dispensed through the plurality of resin channels 120 by a plurality of pumps (not pictured). For example, the liquid resin 118 may be dispensed through the plurality of resin channels 120 via piezoelectric technology or thermal heating technology. The means of moving the liquid resin depends on the viscosity of the liquid resin 118 used during the fabricating method 200. Liquid resin 118 is supplied to the resin well until a desired amount is reached to print the printed part. The sensor 112 may be configured to detect temperature or pressure data related to the liquid resin 118 and relay that information to a control system (not pictured) to regulate the amount of liquid resin 118 provided to the resin well 110.

At operation 220, as shown in FIG. 3B, the plurality of LEDs 109 are switched on to emit a low wavelength light 128. The low wavelength light 128 may include UV light, blue light, light including about 405 nm wavelength, or light including about 450 nm wavelength. The plurality of LEDs 109 emit low wavelength light 128 upwards towards the stage 114, the resin well 110, and the liquid resin 118 disposed within the resin well 110. The stage 114 includes a material such as glass in order to allow the low wavelength light 128 to pass through the stage 114 and cure the liquid resin 118. Once cured, the liquid resin 118 hardens to form a cured resin. The cured resin forms a printed part 122. The plurality of LEDs 109 are switched on according to a pre-determined pattern to print the desired shape of the printed part 122. Further, the plurality of LEDs 109 may emit different wavelengths of low wavelength light 128. The plurality of LEDs 109 are switched on according to what wavelength will cure the liquid resin 118 disposed in the resin well 110. Additionally or alternatively, a microlens or a microlens array 124 is included over the wells 106 to further control and direct the low wavelength light 128 towards specific areas of the resin well 110 in order to provide detailed curing to build the printed part 122.

At operation 230, as shown in FIG. 3C, the printed part 122 is lifted slightly from the resin well 110. As shown in FIG. 3C, the resin well 110 is empty after the curing step at operation 220. However, it is to be understood that the curing step at operation 220 reduces the amount of liquid resin present in the resin well 110 (e.g., some amount of liquid resin may remain uncured in the resin well 110). During operation 230, the sensors 112 relay information to the controller regarding the level of liquid resin 118 in the resin well 110. In other embodiments, the level of liquid resin 118 is calculated by a controller (not shown) based on the cure of the printed part 122. Alternatively or additionally, the printed part 122 remains at least partially submerged in the resin well 110 during operation 230.

At operation 240, as shown in FIG. 3D, the printed part 122 is lowered into the resin well 110. Liquid resin 118 is supplied to the resin well 110 via the plurality of resin channels 120. The plurality of resin channels 120 are microfluidic channels. The liquid resin 118 is supplied from a resin source (not pictured). The liquid resin 118 is dispensed through the plurality of resin channels 120 by a plurality of pumps (not pictured). For example, the liquid resin 118 may be dispensed through the plurality of resin channels via piezoelectric technology or thermal heating technology. The means of moving the liquid resin depends on the viscosity of the liquid resin 118 used during the fabricating method 200. Liquid resin 118 is supplied to the resin well until a desired amount is reached to print the printed part 122. At operation 250 the method 200 is repeated until the printed part 122 is complete according to the pattern.

### ADDITIONAL ASPECTS

The present disclosure provides, among others, the following aspects, each of which may be considered as optionally including any alternate aspects.

Clause 1. a printed part comprising cured resin, wherein the printed part is made by a process comprising:
supplying a liquid resin to a resin well via a plurality of resin channels;
curing the liquid resin via curing the liquid resin via a light with a wavelength of about 365 nm to about 450 nm emitted by a plurality of LEDs according to a pattern, the plurality of LEDs disposed within a device, the device comprising:
   a backplane, the backplane having a backplane surface, the backplane surface including the plurality of LEDs;
   sub-pixel isolation (SI) structures disposed over the backplane surface and between the plurality of LEDs, the SI structures defining a plurality of wells, the plurality of wells having a transparent material disposed therein;
   a stage, the stage disposed over the wells; and
   the resin well, the resin well disposed over the stage;
lifting the printed part at least partially from the resin well, the printed part comprising cured resin;
lowering the printed part into the resin well; and supplying additional liquid resin to the resin well through the plurality of resin channels.
   Clause 2. The printed part of clause 1, wherein the device further comprises a plurality of sensors disposed within the wells, the plurality of sensors include temperature sensors, pressure sensors, or optical sensors.
   Clause 3. The printed part of clause 2, further comprising the plurality of sensors collecting a plurality of data and relaying the data to a controller.
   Clause 4. The printed part of clause 3, further comprising the controller controlling a supply of the liquid resin.
   Clause 5. The printed part of clause 1, wherein the resin channels are microfluidic channels.
   Clause 6. The printed part of clause 1, wherein supplying the liquid resin through the plurality of resin channels includes piezoelectric technology or thermal heating technology.
   Clause 7. The printed part of clause 1, wherein the plurality of LEDs emit the low wavelength at a wavelength of about 365 nm to about 450 nm.
   Clause 8. The printed part of clause 1, wherein the pattern determines which LEDs to switch on to cure the liquid resin.

Overall, the various embodiments of the present disclosure generally relate to liquid interface 3D printing methods and devices. Specifically, embodiments described herein provide methods and devices for supplying liquid resin to a 3D printing interface and curing portions of 3D printed part with light emitting diodes (LEDs). The use of the disclosed methods and devices allows for less steps to be required to 3D print printed parts than conventional methods. The methods and devices disclosed herein provide a detailed and controlled curing process using LEDs and a controlled method to provide liquid resin during the printing process.

While the foregoing is directed to embodiments of the present disclosure, other and further embodiments of the disclosure may be devised without departing from the basic scope thereof, and the scope thereof is determined by the claims that follow.

What is claimed is:

1. A device, comprising:
a backplane, the backplane having a backplane surface, the backplane surface including a plurality of LEDs;
sub-pixel isolation (SI) structures disposed over the backplane surface and between the plurality of LEDs, the SI structures defining a plurality of wells, the plurality of wells having a transparent material disposed therein;
a stage, the stage disposed over the plurality of wells; and
a resin well, the resin well disposed over the stage.

2. The device of claim 1, further comprising a plurality of sensors.

3. The device of claim 2, wherein the plurality of sensors include temperature sensors, pressure sensors, or optical sensors.

4. The device of claim 1, further comprising a microlens or a microlens array, the microlens or microlens array disposed over at least one well.

5. The device of claim 1, wherein the LEDs are micro-LEDs.

6. The device of claim 1, wherein the plurality of LEDs are operable to emit light at a low wavelength, the low wavelength is about 365 nm to about 450 nm.

7. A device, comprising:
a backplane, the backplane having a backplane surface, the backplane surface including a plurality of LEDs;
sub-pixel isolation (SI) structures disposed over the backplane surface and between the plurality of LEDs, the SI structures defining a plurality of wells, the plurality of wells having a transparent material disposed in the plurality of wells;
a stage, the stage disposed over the plurality of wells;
a resin well, the resin well disposed over the stage; and
a plurality of resin channels, the plurality of resin channels coupled to the resin well, the resin channels extending through the backplane, the wells and the stage.

8. The device of claim 7, further comprising a plurality of sensors, the plurality of sensors include temperature sensors, pressure sensors, or optical sensors.

9. The device of claim 7, wherein the plurality of resin channels are operable to supply liquid resin to the resin well.

10. The device of claim 7, wherein the plurality of resin channels are microfluidic channels.

11. The device of claim 7, wherein the plurality of LEDs are micro-LEDs.

12. A method for fabricating a printed part, comprising:
supplying a liquid resin to a resin well via a plurality of resin channels;
curing the liquid resin via a light emitted by a plurality of LEDs according to a pattern, the plurality of LEDs disposed within a device, the device comprising:
a backplane, the backplane having a backplane surface, the backplane surface including the plurality of LEDs;
sub-pixel isolation (SI) structures disposed over the backplane surface and between the plurality of LEDs, the SI structures defining a plurality of wells, the plurality of wells having a transparent material disposed therein;
a stage, the stage disposed over the wells; and
the resin well, the resin well disposed over the stage;
lifting the printed part at least partially from the resin well, the printed part comprising cured resin;
lowering the printed part into the resin well; and
supplying additional liquid resin to the resin well through the plurality of resin channels.

13. The method for fabricating the printed part of claim 12, wherein the device further comprises a plurality of sensors disposed within the wells, the plurality of sensors include temperature sensors, pressure sensors, or optical sensors.

14. The method of fabricating the printed part of claim 13, further comprising the plurality of sensors collecting a plurality of data and relaying the data to a controller.

15. The method of fabricating the printed part of claim 14, further comprising the controller controlling a supply of the liquid resin.

16. The method of fabricating the printed part of claim 12, wherein the resin channels are microfluidic channels.

17. The method of fabricating the printed part of claim 12, wherein supplying the liquid resin through the plurality of resin channels includes piezoelectric technology or thermal heating technology.

18. The method of fabricating the printed part of claim 12, wherein the light emitted by the plurality of LEDs is a low wavelength, the low wavelength is about 365 nm to about 450 nm.

19. The method of fabricating the printed part of claim 12, wherein the pattern determines which LEDs to switch on to cure the liquid resin.

20. The method of fabricating the printed part of claim 12, wherein the method is repeated until the printed part is complete.
